(19) United States
(12) Patent Application Publication
(10) Pub. No.: US 2026/0057637 A1
(43) Pub. Date: Feb. 26, 2026

(54) METHOD, DEVICE, ELECTRONIC EQUIPMENT, AND MEDIUM FOR EXTRACTING BUILDING FACADE STRUCTURE

(71) Applicants: WSGRI Engineering & Surveying Incorporation Limited, Wuhan (CN); WSGRI Smart City(Wuhan) Engineering Technology Co.,Ltd., Wuhan (CN)

(72) Inventors: Hui Li, Wuhan (CN); Shugang Zhao, Wuhan (CN); Lei He, Wuhan (CN); Wenjie Yu, Wuhan (CN); Siyuan Han, Wuhan (CN); Ke Xu, Wuhan (CN); Feng Wu, Wuhan (CN); Yahui Wu, Wuhan (CN); Yufeng Xiao, Wuhan (CN)

(21) Appl. No.: 19/012,115

(22) Filed: Jan. 7, 2025

Related U.S. Application Data
(63) Continuation of application No. PCT/CN2024/134590, filed on Nov. 26, 2024.

(30) Foreign Application Priority Data
Aug. 22, 2024 (CN) 202411160180X

(51) Int. Cl. G06V 10/40; G06T 7/11

(52) U.S. Cl. CPC G06V 10/40; G06T 7/11; G06T 2207/10028

(57) ABSTRACT

Disclosed is a method, device, electronic equipment, and medium for extracting building facade structure, the method comprises acquiring first point cloud data of a building facade and establishing a three-dimensional space based on the first point cloud data; dividing the three-dimensional space into multiple voxels and performing supervoxel clustering on the multiple voxels to obtain at least one first supervoxel; determining the difference between the normal vectors of adjacent points within the first supervoxel for each first supervoxel; identifying points with differences greater than a preset difference threshold as noise points and removing them to obtain second point cloud data; and determining the facade structure of the building. By performing clustering and then screening out noise points in the point cloud based on the normal vectors of the points within the first supervoxel obtained from the clustering, this disclosure can improve the validity of the point cloud data.

### FIELD OF THE DISCLOSURE

The disclosure relates to the technical field of building structure detection, in particular to a method, device, electronic equipment, and medium for extracting building facade structure.

### BACKGROUND

The facade structure of a building refers to the appearance and construction of its exterior walls, encompassing walls, windows, doors, decorative elements, and other components. It is the part of the building that directly interfaces with the external environment. Accurate extraction of the facade structure of a building is fundamental to research areas such as building image stitching, feature extraction from 3D laser point clouds, and 3D reconstruction.

In existing technologies, the extraction of building facade structures often relies on three-dimensional laser scanning technology to obtain point cloud data of the building facade. From this point cloud, feature points or contour points are then extracted based on their inherent attributes, such as coordinates and reflection intensity, to construct the building facade structure. However, in current technologies, the point cloud data acquired for buildings frequently contains numerous noise points that are difficult to effectively remove. This results in inaccuracies when constructing the building facade structure based on the point cloud data.

### SUMMARY

In view of this, it is necessary to provide a method, device, electronic equipment, and medium for extracting building facade structure to address the technical problem of inaccurate facade structures constructed based on point cloud data.

This disclosure provides a method for extracting building facade structure, comprising:
acquiring first point cloud data of a building facade and establishing a three-dimensional space based on the first point cloud data;
dividing the three-dimensional space into multiple voxels, and performing supervoxel clustering on the multiple voxels based on the point cloud within them to obtain at least one first supervoxel;
determining the difference between the normal vectors of adjacent points within the first supervoxel for each first supervoxel;
identifying points with differences exceeding a preset difference threshold as noise points, and removing the data of these noise points from the first point cloud data to obtain second point cloud data;
determining structure of the building facade based on the second point cloud data.

In a preferred embodiment, the step of performing supervoxel clustering on the multiple voxels based on the point cloud within them to obtain at least one first supervoxel comprises:
determining the point cloud in each voxel based on the first point cloud data;
determining a first similarity between voxels based on the point cloud in each voxel; the first similarity is positional similarity;
performing supervoxel clustering on the multiple voxels based on the first similarity to obtain at least one first supervoxel.

In a preferred embodiment, the step of determining structure of the building facade based on the second point cloud data comprises:
determining the point cloud in each voxel based on the second point cloud data;
determining a second similarity between voxels based on the point clouds in each voxel; the second similarity is determined based on positional similarity, color similarity, and normal vector similarity;
performing supervoxel clustering on the multiple voxels based on the second similarity to obtain at least one second supervoxel;
determining the structure of the building facade based on the second supervoxel.

In a preferred embodiment, the step of determining the second similarity between voxels based on the point cloud within each voxel comprises:
identifying a target voxel and a search range; wherein the target voxel is a preset voxel, and a neighboring voxel with the smallest second similarity among the neighboring voxels of the preset voxel;
calculating the second similarity for the target voxel and its neighboring voxels within the search range; the calculation method for the second similarity is as follows:

$$D = \sqrt{{w}_{c} {D}_{c}^{2} + \frac{{w}_{s} {D}_{s}^{2}}{2 {R}_{s}^{2}} + {w}_{n} {D}_{n}^{2}}$$

where, D represents the second similarity, D_{c} denotes the color difference between two voxels, Dₛ represents the distance difference between two voxels, Dₙ represents the normal vector difference of the point clouds between two voxels, Rₛ is the search range, and w_{c}, wₛ, and wₙ are the influence weights for color difference, distance difference, and normal vector difference, respectively.

In a preferred embodiment, the step of determining the structure of a building facade based on the second point cloud data comprises:
performing plane fitting processing on the second point cloud data to obtain fitted planes;
clustering the second supervoxels based on the fitted planes and the second supervoxels to obtain clustered blocks;
determining the structure of the building facade based on the clustered blocks.

In a preferred embodiment, the step of clustering the second supervoxels based on the fitted planes and the second supervoxels to obtain clustered blocks comprises: determining the target fitting points corresponding to the fitted planes;
determining the projection points of the target fitting points on their respective fitted planes;
clustering the second supervoxels based on the projection points using the Constrained Planar Cuts algorithm to obtain clustered blocks.

In a preferred embodiment, the step of determining the structure of a building facade based on the clustered blocks comprises:
determining a concave-convex structural relationship of the clustered blocks using the Constrained Planar Cuts algorithm;
determining the structure of the building facade based on the clustered blocks and their concave-convex structural relationship.

This disclosure also provides a device for extracting building facade structure, comprising a space establishment module, a clustering module, a normal vector difference determination module, a point cloud data filtering module, and a facade structure determination module; wherein:
the space establishment module is used to acquire first point cloud data of a building facade and establish a three-dimensional space based on the first point cloud data;
the clustering module divides the three-dimensional space into multiple voxels and performs supervoxel clustering on the multiple voxels based on the point cloud within them to obtain at least one first supervoxel;
the normal vector difference determination module determines the difference between the normal vectors of adjacent points within the first supervoxel for each first supervoxel;
the point cloud data filtering module identifies points with differences exceeding a preset difference threshold as noise points, and removing the data of these noise points from the first point cloud data to obtain second point cloud data;
the facade structure determination module determines structure of the building facade based on the second point cloud data.

This disclosure also provides an electronic device, comprising a memory and a processor, wherein:
the memory is used for storing programs;
the processor, coupled to the memory, is used for executing the programs stored in the memory to implement the steps of the method for extracting building facade structure.

This disclosure also provides a computer-readable storage medium, which stores computer-readable programs, when the programs are executed by a processor, the steps of the method for extracting building facade structure are implemented.

Compared to the existing technology, this disclosure enhances the accuracy and effectiveness of point cloud data by initially acquiring the first point cloud data of a building facade. It then divides the point cloud in three-dimensional space into individual voxels based on this first point cloud data. Subsequently, it clusters the voxels based on their respective point clouds to obtain the first supervoxel. For each first supervoxel, the normal vectors of the points are determined separately. When the difference between the normal vectors of two adjacent points within a first supervoxel is less than or equal to a preset threshold, these two points are determined to be on the same facade and are considered valid points that need to be retained. Conversely, if the difference in normal vectors between two adjacent points within a first supervoxel exceeds the preset threshold, these two points are considered not to be on the same facade. Therefore, these points can be identified as noise and removed, ensuring that the points within each first supervoxel are as likely as possible to be on the same facade. This process improves the validity and accuracy of the point cloud data. Furthermore, when constructing the building facade structure using the second point cloud data, which has had noise points removed, the accuracy of the facade structure can be enhanced.

### BRIEF DESCRIPTION OF THE DRAWINGS

FIG. 1 is a flowchart illustrating an embodiment of the method for extracting building facade structure provided in this disclosure;

FIG. 2 is a flowchart illustrating another embodiment of the method for extracting building facade structure provided in this disclosure;

FIG. 3 is a flowchart diagram illustrating a preprocessing process for point cloud data provided in this disclosure;

FIG. 4 is a flowchart diagram illustrating a point cloud segmentation method based on plane feature preservation provided in this disclosure;

FIG. 5 is a flowchart diagram illustrating a point cloud clustering method based on a Constrained Planar Cuts algorithm provided in this disclosure;

FIG. 6 is a structural diagram illustrating an embodiment of a device for extracting building facade structure provided in this disclosure.

### DETAILED DESCRIPTION OF PREFERRED EMBODIMENTS

Below, the technical solutions in the embodiments of this disclosure will be described clearly and comprehensively with reference to the accompanying drawings in the embodiments of this disclosure. It is evident that the described embodiments are merely a portion of the embodiments of this disclosure, rather than all of them. All other embodiments obtained by those skilled in the art without creative efforts based on the embodiments in this disclosure fall within the scope of protection of this disclosure.

In the description of the embodiments of this disclosure, unless otherwise specified, the term “plurality” means two or more. The expression “and/or” is used to describe the associative relationship between associated objects, indicating that there can be three relationships, for example: A and/or B, which can represent the following three cases: A alone, both A and B, and B alone.

The descriptions such as “first”, “second”, and so on, involved in the embodiments of this disclosure are used for descriptive purposes only and should not be understood as indicating or implying their relative importance or implicitly specifying the number of technical features indicated. Therefore, technical features qualified by “first”, “second”, and so on, can explicitly or implicitly include at least one such feature.

The mention of “embodiment” in this disclosure implies that specific features, structures, or characteristics described in conjunction with the embodiments can be included in at least one embodiment of this disclosure. The appearance of this phrase at various locations in the specification does not necessarily refer to the same embodiment, nor are they independent or alternative embodiments that are mutually exclusive with other embodiments. Those skilled in the art understand explicitly and implicitly that the embodiments described herein can be combined with other embodiments.

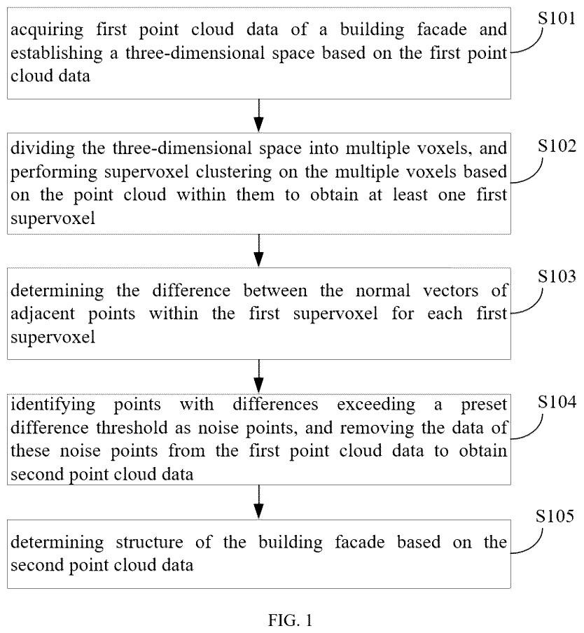

With reference to FIG. 1, a flowchart diagram illustrating an embodiment of the method for extracting building facade structure provided in this disclosure is shown. The method comprises:
Step S101, acquiring first point cloud data of a building facade and establishing a three-dimensional space based on the first point cloud data.
Step S102, dividing the three-dimensional space into multiple voxels, and performing supervoxel clustering on the multiple voxels based on the point cloud within them to obtain at least one first supervoxel.
Step S103, determining the difference between the normal vectors of adjacent points within the first supervoxel for each first supervoxel.
Step S104, identifying points with differences exceeding a preset difference threshold as noise points, and removing the data of these noise points from the first point cloud data to obtain second point cloud data.
Step S105, determining structure of the building facade based on the second point cloud data.

In this embodiment, the first point cloud data of the building facade can be obtained by scanning the building using a 3D laser scanner. The first point cloud data may include position data, color data, and other information of the point clouds. After obtaining the first point cloud data, registration processing and preliminary noise reduction processing can be performed on the first point cloud data. Preliminary noise reduction processing includes removing non-facade point clouds, air noise points, large ground objects, and fine ground objects.

Subsequently, the first point cloud data, which has undergone registration and preliminary noise reduction processing, can be subjected to voxelization process. The voxelization process involves establishing a 3D space based on the first point cloud data such that the 3D space encompasses all the point clouds recorded in the first point cloud data. The 3D space is then divided into multiple voxels, distributing the aforementioned point clouds among these voxels. Here, a voxel is short for “volumetric pixel” and represents a basic unit in a 3D space, analogous to a pixel in a 2D image. Voxels are used to represent a point or a small volumetric region in a 3D dataset. In an example of this embodiment, the voxelization process can specifically involve: searching for two points with the minimum and maximum coordinates in the first point cloud data to serve as two vertices of the 3D space, with the line connecting these vertices forming the diagonal of the 3D space, which contains all the point clouds; then, dividing the 3D space into multiple voxels according to a voxel resolution, where each voxel represents a subspace within the 3D space, and the point clouds are distributed among these voxels; finally, establishing a coordinate system for the 3D space with the point of minimum coordinates as the origin and following the right-hand rule, and determining the centroid of each voxel based on the point clouds within each voxel, with the coordinates of the voxel centroid in the coordinate system serving as the coordinates of the voxel. It should be noted that those skilled in the art can also establish the 3D space and divide it into voxels using other methods.

After voxelizing the first point cloud data, supervoxel clustering can be performed on the voxels. Specifically, the voxels can be clustered into at least one first supervoxel based on at least one factor among positional similarity, color similarity, and normal vector similarity of the point clouds within the voxels. Supervoxel clustering is an image processing technique that segments an image into multiple regions composed of similar pixels or voxels, known as “supervoxels.” Rather than simply dividing the image into grids, supervoxel clustering aggregates adjacent and similar pixels or voxels based on features such as color, brightness, texture, and so on, forming regions with a certain degree of connectivity.

For each first supervoxel, the normal vectors of the points within the supervoxel can be calculated separately. Then, it is determined whether the difference between the normal vectors of adjacent points in the first supervoxel is greater than a preset difference threshold. If the difference is less than or equal to the preset difference threshold, the two points can be determined to be located on the same facade and are valid points that need to be retained. If the difference is greater than the threshold, the two points can be determined to be not located on the same facade, and therefore can be identified as noise points and removed. This process ensures that the points within each first supervoxel are as much as possible located on the same facade, thereby preserving the planar features within each first supervoxel.

Finally, the data of noise points in the first point cloud data are removed to obtain second point cloud data, and the facade structure of the building is determined based on the second point cloud data.

The embodiments of this disclosure achieve the following: after voxelizing the first point cloud data of the building facade and performing supervoxel clustering to obtain the first supervoxels, noise points within each first supervoxel are identified based on the differences in normal vectors between adjacent points. Subsequently, the structure of the building facade is constructed using the second point cloud data, which has had the noise point data removed. This approach improves the accuracy of the facade structure.

In one embodiment, step S102 specifically comprises: determining the point cloud in each voxel based on the first point cloud data; determining a first similarity between voxels based on the point cloud in each voxel; the first similarity is positional similarity; and performing supervoxel clustering on the multiple voxels based on the first similarity to obtain at least one first supervoxel. In this embodiment, clustering of the voxels can be performed solely based on positional similarity, simplifying the clustering process.

In one embodiment, after removing noise points, voxel clustering can be performed anew based on the point clouds within the voxels. Therefore, step S105 specifically comprises: determining the point cloud in each voxel based on the second point cloud data; determining a second similarity between voxels based on the point clouds in each voxel; the second similarity is determined based on positional similarity, color similarity, and normal vector similarity; performing supervoxel clustering on the multiple voxels based on the second similarity to obtain at least one second supervoxel; and determining the structure of the building facade based on the second supervoxel. In this embodiment, on the one hand, voxels are re-clustered based on the second point cloud data with noise points removed. On the other hand, compared to the previous clustering process, more factors are considered in the re-clustering of the voxels, resulting in more accurate clustering results. Therefore, when determining the structure of the building facade based on the current clustering results, the accuracy of the facade structure can be improved.

In an embodiment, the step of determining the second similarity between voxels based on the point cloud within each voxel can specifically comprise: identifying a target voxel and a search range; wherein the target voxel is a preset voxel, and a neighboring voxel with the smallest second similarity among the neighboring voxels of the preset voxel; calculating the second similarity for the target voxel and its neighboring voxels within the search range; the calculation method for the second similarity is as follows:

$$D = \sqrt{{w}_{c} {D}_{c}^{2} + \frac{{w}_{s} {D}_{s}^{2}}{2 {R}_{s}^{2}} + {w}_{n} {D}_{n}^{2}}$$

where, D represents the second similarity, D_{c} denotes the color difference between two voxels, Dₛ represents the distance difference between two voxels, Dₙ represents the normal vector difference of the point clouds between two voxels, Rₛ is the search range, and w_{c}, wₛ, and wₙ are the influence weights for color difference, distance difference, and normal vector difference, respectively.

In this embodiment, a reasonable initial seed voxel spacing R_seed can be set first. Then, a uniformly distributed set of initial seed voxels is selected in the three-dimensional space according to this spacing, with each initial seed voxel (the preset voxel, or the target voxel) serving as a distinct category from other initial seed voxels. Since the point cloud cannot fill the voxel space completely, there exist isolated seed voxels in the initial seed voxel set that do not contain any points. Therefore, a filtering and denoising process is required to remove these isolated seed voxels from the set, thereby improving the efficiency of supervoxel clustering. Subsequently, the search range is obtained, and with each initial seed voxel as the starting point, the neighboring voxels of this initial seed voxel within the search range are identified. The second similarity is calculated between the initial seed voxel and its neighboring voxels, and similar neighboring voxels are grouped into the same category as the initial seed voxel.

After traversing the adjacent voxels of all initial seed voxels, the adjacent voxel with the least similarity is labeled. Simultaneously, using this labeled adjacent voxel (the target voxel) as the starting point for the search, traversing the adjacent voxels within the search range until the second similarity calculation is completed for all adjacent voxels outside the initial seed voxel.

Finally, the number of voxels contained in each category is judged. If it is less than the established minimum threshold, that category is merged into an adjacent category.

In an embodiment, the step of determining the structure of a building facade based on the second point cloud data specifically comprises: performing plane fitting processing on the second point cloud data to obtain fitted planes; clustering the second supervoxels based on the fitted planes and the second supervoxels to obtain clustered blocks; and determining the structure of the building facade based on the clustered blocks.

After obtaining the second supervoxels, it is needed to cluster the second supervoxels again to obtain the structure of the building facade. However, research has found that when clustering the second supervoxels, the clustering result tends to separate large facade surfaces of buildings into small ones, while in reality, the small and large facade surfaces should belong to the same facade, and the small facade surfaces should not be separated individually. After studying this phenomenon, it was found that the root cause of this issue is the roughness of the large facade surfaces of the building. Therefore, to solve the above problem, in this embodiment, plane fitting processing is first performed on the second point cloud data to obtain smooth fitted planes, and then clustering processing is performed on the second supervoxels based on these fitted planes to obtain clustered blocks. The method of clustering point clouds of building facades based on plane fitting has higher accuracy in block recognition. The plane fitting algorithm can be Principal Component Analysis (PCA).

In an embodiment, the step of clustering the second supervoxels based on the fitted planes and the second supervoxels to obtain clustered blocks comprises: determining the target fitting points corresponding to the fitted planes; determining the projection points of the target fitting points on their respective fitted planes; and clustering the second supervoxels based on the projection points using the Constrained Planar Cuts (CPC) algorithm to obtain clustered blocks. The projection points can be used as input for the CPC algorithm, and the second supervoxels can be re-clustered using the CPC algorithm to obtain clustered blocks, which represent large facade surfaces of buildings. The projection point data has clear normal information and filters out the impact of small concave areas on the large facade surfaces of buildings on block recognition. The method of clustering point clouds of building facades based on an improved CPC algorithm based on plane fitting has higher accuracy in block recognition, fundamentally solving the issue of completeness in building facade recognition.

In an embodiment, the step of determining the structure of a building facade based on the clustered blocks comprises: determining a concave-convex structural relationship of the clustered blocks using the Constrained Planar Cuts algorithm; and determining the structure of the building facade based on the clustered blocks and their concave-convex structural relationship.

The CPC algorithm can determine the convex-concave structural relationship of clustering blocks based on the Euclidean Edge Cloud (EEC). The concept of EEC is quite intriguing because convexity and concavity are defined on adjacent “patches,” in other words, on the edges connecting neighboring “patches.” By abstracting each edge into a point cloud, we obtain a point cloud with convex-concave information. We assign a weight of 1 to concave edges and 0 to others, and define the point cloud with red and blue colors. If there are more blue points, the area is more concave and should be cut. The problem then transforms into finding a plane using the blue points. The Random Sample Consensus (RanSaC) algorithm is used to find the most likely plane from the point cloud, while an evaluation function is introduced to assess the quality of the segmentation. The evaluation function is:

$${S}_{m} = \frac{1}{\vert {p}_{m} \vert} {\sum }_{\text{?}} {w}_{\text{?}} ,$$

$$\text{?} \text{indicates text missing or illegible when filed}$$

where, Sₘ represents the quality of the segmentation, Pₘ represents the distance from points in the EEC point set to the plane, and wᵢ represents the weight of each EEC point.

In current technologies, the extraction of building facade structures often relies on spatial features of point clouds, such as spatial resolution. Therefore, for areas with uneven point cloud density, these methods may encounter problems such as incorrect extraction or omission of structural lines. However, this disclosure does not rely on spatial resolution or point cloud density when extracting building facade structures, thus achieving higher accuracy.

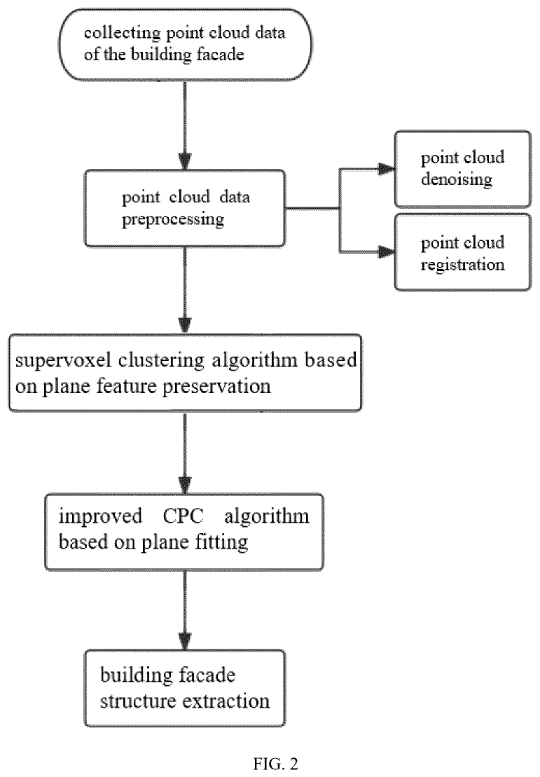

Referring to FIG. 2, it shows a flowchart of another embodiment of the building facade structure extraction method provided in this disclosure. First, point cloud data of the building facade is collected and preprocessed through steps such as point cloud denoising and point cloud registration. Then, using a supervoxel clustering algorithm based on plane feature preservation, noise points in the point cloud are filtered out, and valid points in the point cloud are retained. Finally, the CPC algorithm based on plane fitting is used to determine the facade structure of the building.

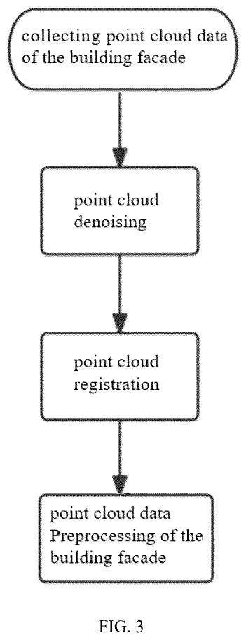

Referring to FIG. 3, it shows a schematic diagram of a point cloud data preprocessing flowchart provided in this disclosure. The preprocessing of point cloud data mainly comprises point cloud denoising and point cloud registration.

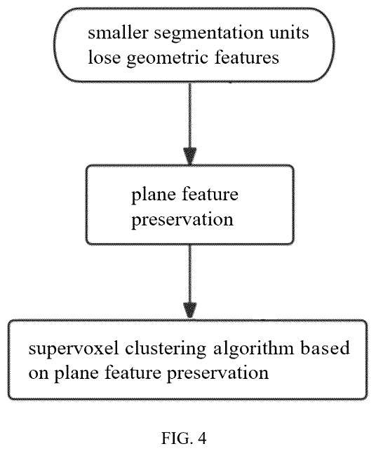

Referring to FIG. 4, it shows a schematic diagram of a flowchart for a point cloud clustering method based on plane feature preservation provided in this disclosure. Plane feature preservation, which refers to the process of screening out noise points that do not belong to the same facade within a supervoxel after supervoxel clustering, and retaining valid points that belong to the same facade, thereby preserving the plane features of the supervoxel.

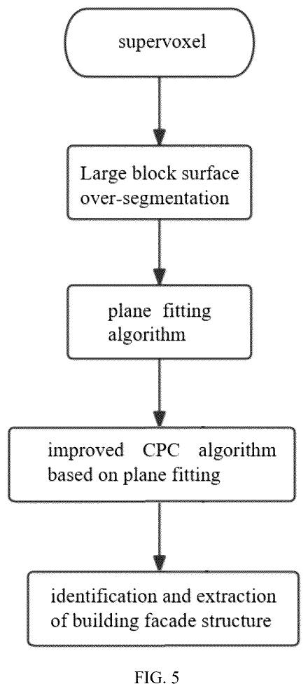

Referring to FIG. 5, it illustrates a schematic flowchart of a point cloud clustering method based on the Constrained Planar Cuts algorithm provided in this disclosure. When further clustering supervoxels based on the CPC algorithm, incorporating a plane fitting algorithm can enhance the accuracy of cluster block identification.

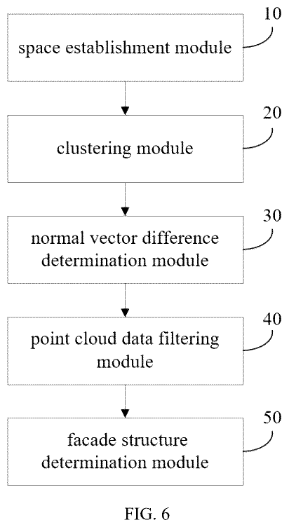

Referring to FIG. 6, it illustrates a schematic diagram of one embodiment of the device for extracting building facade structure provided by this disclosure. The device comprises:
a space establishment module 10, which is used to acquire first point cloud data of a building facade and establish a three-dimensional space based on the first point cloud data;
a clustering module 20, which divides the three-dimensional space into multiple voxels and performs supervoxel clustering on the multiple voxels based on the point cloud within them to obtain at least one first supervoxel;
a normal vector difference determination module 30, which determines the difference between the normal vectors of adjacent points within the first supervoxel for each first supervoxel;
a point cloud data filtering module 40, which identifies points with differences exceeding a preset difference threshold as noise points, and removing the data of these noise points from the first point cloud data to obtain second point cloud data;
a facade structure determination module 50, which determines structure of the building facade based on the second point cloud data.

It should be noted that the implementation principles or processes of the aforementioned modules can refer to the previously described embodiments of building facade structure extraction, and will not be elaborated on here one by one.

Those skilled in the art will appreciate that the entire or partial process of implementing the methods described in the aforementioned embodiments can be accomplished by instructing relevant hardware through a computer program. Such programs can be stored in computer-readable storage media, which include disks, optical discs, read-only memory (ROM), random access memory (RAM), and so forth.

The above description is merely the preferred embodiments of this disclosure, but the protection scope of this disclosure is not limited to these. Any variations or substitutions that can be easily conceived by those skilled in the art within the technical scope disclosed by this disclosure should be encompassed within the protection scope of this disclosure.

What is claimed is:

1. A method for extracting building facade structure, comprising:
acquiring first point cloud data of a building facade and establishing a three-dimensional space based on the first point cloud data;
dividing the three-dimensional space into multiple voxels, and performing supervoxel clustering on the multiple voxels based on the point cloud within them to obtain at least one first supervoxel;
determining the difference between the normal vectors of adjacent points within the first supervoxel for each first supervoxel;
identifying points with differences exceeding a preset difference threshold as noise points, and removing the data of these noise points from the first point cloud data to obtain second point cloud data;
determining structure of the building facade based on the second point cloud data.

2. The method for extracting building facade structure, wherein the step of performing supervoxel clustering on the multiple voxels based on the point cloud within them to obtain at least one first supervoxel comprises:
determining the point cloud in each voxel based on the first point cloud data;
determining a first similarity between voxels based on the point cloud in each voxel; the first similarity is positional similarity;
performing supervoxel clustering on the multiple voxels based on the first similarity to obtain at least one first supervoxel.

3. The method for extracting building facade structure according to claim 1, wherein the step of determining structure of the building facade based on the second point cloud data comprises:
determining the point cloud in each voxel based on the second point cloud data;
determining a second similarity between voxels based on the point clouds in each voxel;
the second similarity is determined based on positional similarity, color similarity, and normal vector similarity;
performing supervoxel clustering on the multiple voxels based on the second similarity to obtain at least one second supervoxel;
determining the structure of the building facade based on the second supervoxel.

4. The method for extracting building facade structure according to claim 3, wherein the step of determining the second similarity between voxels based on the point cloud within each voxel comprises:
identifying a target voxel and a search range; wherein the target voxel is a preset voxel, and a neighboring voxel with the smallest second similarity among the neighboring voxels of the preset voxel;
calculating the second similarity for the target voxel and its neighboring voxels within the search range; the calculation method for the second similarity is as follows:
$$D = \sqrt{{w}_{c} {D}_{c}^{2} + \frac{{w}_{s} {D}_{s}^{2}}{2 {R}_{s}^{2}} + {w}_{n} {D}_{n}^{2}}$$
where, D represents the second similarity, D_{c} denotes the color difference between two voxels, Dₛ represents the distance difference between two voxels, Dₙ represents the normal vector difference of the point clouds between two voxels, Rₛ is the search range, and w_{c}, wₛ, and wₙ are the influence weights for color difference, distance difference, and normal vector difference, respectively.

5. The method for extracting building facade structure according to claim 3, wherein the step of determining the structure of a building facade based on the second point cloud data comprises:
performing plane fitting processing on the second point cloud data to obtain fitted planes;
clustering the second supervoxels based on the fitted planes and the second supervoxels to obtain clustered blocks;
determining the structure of the building facade based on the clustered blocks.

6. The method for extracting building facade structure according to claim 5, wherein the step of clustering the second supervoxels based on the fitted planes and the second supervoxels to obtain clustered blocks comprises:
determining the target fitting points corresponding to the fitted planes;
determining the projection points of the target fitting points on their respective fitted planes;
clustering the second supervoxels based on the projection points using the Constrained Planar Cuts (CPC) algorithm to obtain clustered blocks.

7. The method for extracting building facade structure according to claim 6, wherein the step of determining the structure of a building facade based on the clustered blocks comprises:
determining a concave-convex structural relationship of the clustered blocks using the Constrained Planar Cuts algorithm;
determining the structure of the building facade based on the clustered blocks and their concave-convex structural relationship.

8. A device for extracting building facade structure, comprising a space establishment module, a clustering module, a normal vector difference determination module, a point cloud data filtering module, and a facade structure determination module; wherein:
the space establishment module is used to acquire first point cloud data of a building facade and establish a three-dimensional space based on the first point cloud data;
the clustering module divides the three-dimensional space into multiple voxels and performs supervoxel clustering on the multiple voxels based on the point cloud within them to obtain at least one first supervoxel;
the normal vector difference determination module determines the difference between the normal vectors of adjacent points within the first supervoxel for each first supervoxel;
the point cloud data filtering module identifies points with differences exceeding a preset difference threshold as noise points, and removing the data of these noise points from the first point cloud data to obtain second point cloud data;
the facade structure determination module determines structure of the building facade based on the second point cloud data.

9. An electronic device, comprising a memory and a processor, wherein:
the memory is used for storing programs;
the processor, coupled to the memory, is used for executing the programs stored in the memory to implement the steps of the method for extracting building facade structure as claimed in claim 1.

10. A computer-readable storage medium, which stores computer-readable programs, when the programs are executed by a processor, the steps of the method for extracting building facade structure as claimed in claim 1 are implemented.
